(19) United States
(12) Patent Application Publication
(10) Pub. No.: US 2008/0005215 A1
(43) Pub. Date: Jan. 3, 2008

(54) System and method for reducing click using signal averaging on a high order modulator output

(75) Inventors: Andrew Martin Mallinson, Kelowna (CA); Dustin Forman, Kelowna (CA)

Correspondence Address: STEVENS LAW GROUP, P.O. BOX 1667, SAN JOSE, CA, 95109, US

(73) Assignee: ESS Technology, Inc., Fremont, CA (US)

(21) Appl. No.: 11/479,410

(22) Filed: Jun. 30, 2006

(51) Int. Cl. G06F 17/10

(52) U.S. Cl. 708/300

(57) ABSTRACT

The invention has been described in the context of a system and method of removing artifacts from an audio signal during shutdown of the output. The system includes a means by which the average value may be found to be zero or sufficiently close to zero as determined by the resolution of the filter output and a means by which the filter average value being zero or close to zero is used to disconnect (or equivalently change impedance or power) of the device or devices rendering the PWM signal into the analog domain as may be implemented by a Class D bridge chip and disconnection means.

### BACKGROUND

In high end audio circuit applications, high quality signal processing is essential for quality sound. Since high quality audio systems are indeed sensitive by their nature, sound artifacts or unwanted noise are more apparent when they occur. For example, it has been observed that artifacts can occur when a zero audio signal is present. This occurs because the value of the signal is not precisely zero. The reason it may not be precisely zero because of induced noise, electrical interference or any other phenomena that introduces unwanted noise. A particular example of such unwanted noise can occur when a multi-disk CD player changes disks. Here, the audio content is zero when the changer is removing one disk and inserting another, but electrical noise is created by the servo motor operation within the CD changer can induce unwanted noise into the audio output.

In a certain classes of audio equipment, such as Class D power amplifiers, this residual and undesirable noise occurs when the audio content is zero, and can be completely removed because it is possible to “switch off” the audio output. For example, when representing a zero audio signal, a Class D power amplifier may be constantly switching the output from a high value (of say 30 v) to a low value (of say −30 v) with approximately equal time spent at each value. Therefore, the average value is half way for example zero volts. To achieve complete silence in the output, such a Class D amplifier may simply cease to switch the signal at all, thus leaving the output to the speakers unconnected and perfectly silent. Typically, therefore, to exploit this possibility, a Class D audio system will have a means to detect zero audio signals, and upon detecting this condition, will cause the Class D output to shut off completely, achieving essentially perfect silence in the loudspeakers. However, it has been observed that the transition from operation with zero audio signals to operation with the output disconnected is not itself free from noise. That is, upon the appearance of zero signals in the audio data, the Class D output falls silent. This is because the output, while still operating, is creating the average zero value. The means to detect zero signals in the audio data will, after a short delay, conclude that the output should now switch off in order to achieve complete silence. When this means activates, the Class D output stage will transition from representing silence as the average signal value of zero (perhaps not completely silently due to the discussed artifacts) to representing silence because the output is switched off or disconnected (now representing complete silence since the output is no longer active). It is observed that this transition itself can be a source of noise (a click is typically heard). Fundamentally, the source of this noise as the system switches from an average value of no signal to a disconnected state is due to the detailed nature of the switching signal while the system is operating.

Specifically, the representation of silence as an average of non-zero output values, +30 v and −30 v for example, is achieved because the output spends equal time at the high value as at the low value—hence the average output is half way, zero volts in this example. Any such averaging process implies a time over which the signal is averaged. For example, if the output signal value has, for the last 10 uS, been at the high value, it will next spend 10 uS at the low value, such that, over the combined interval, 20 us in this example, the average value is mid way, zero volts. Thus, a time over which an average value is zero is a necessary part of the representation of zero when the system is active. This leads to the problem that the click artifact is heard in the transition from the operation with the average value to the operation with the output disconnected, because the act of switching to the disconnected condition truncates the averaging process such that the average value, at the moment of disconnection, may not be zero. As a result, a click will be heard when a Class D audio system attempts to transition from a representation of silence as an average value to a disconnected or non-operating state, because the average signal value at the moment of this transition may not be zero.

Therefore, there exists a need in the art for a system and method able to control the transition of a Class D audio system from operation with average switched values to operation with output disconnection such that no artifact (click) is induced at the moment of transition. As will be seen, the invention provides this in an elegant manner.

### BRIEF SUMMARY OF THE DRAWINGS

FIG. 1 is an illustration of a filter system;

FIG. 2 is an illustration of output signals characteristic of the circuit of FIG. 1;

FIG. 3 is an illustration of a timing diagram of an output signal of the system of FIG. 1 before and after output is disconnected;

FIG. 4 is an illustration of output dither;

FIG. 5 is an up/down circuit;

FIG. 6 is an illustration of factor/average circuits according to the invention; and

FIG. 7 is a flow diagram of a method according to the invention.

### DETAILED DESCRIPTION

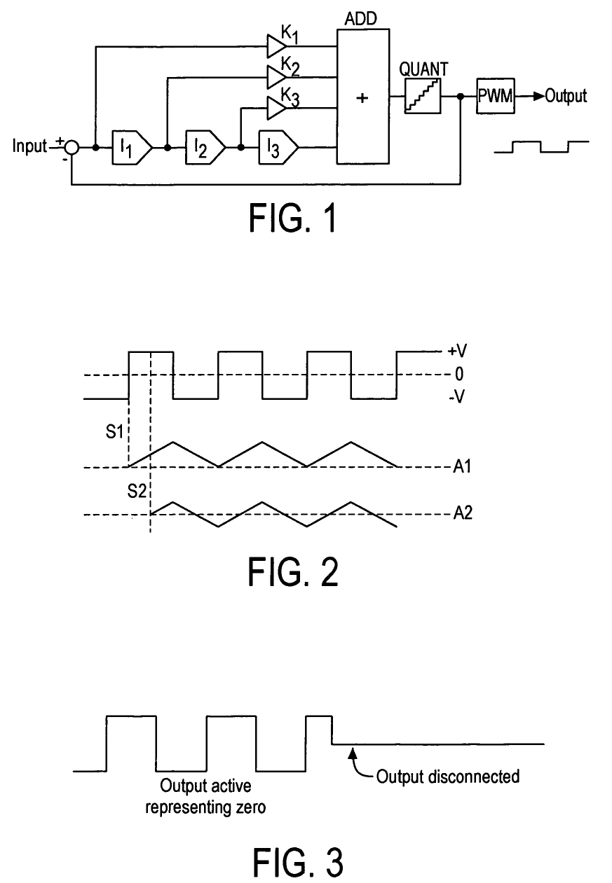

The invention is directed to a system and method that solves the audio artifact problem discussed above. The system implements a method of tracking the average value of the signal presented to the Class driver stage (the “bridge” or “bridge chip”) of the audio system and indicates to the shut down means the correct time at which to switch to the disconnected stage such that no click or pop is created. An example of a typical system to which the invention applies is shown in FIG. 1.

The system according to one embodiment of the invention is directed to a system for use in an audio signal processor to remove sound artifacts from an audio signal during shutdown of the output that has an input for receiving an audio input signal, a noise shaping modulator to reduce the input bit width having an order of two or more, a circuit by which the reduced bit representation is converted to a single bit time domain output as may be done by a PWM element, a circuit by which a filtered or average value of the output single bit time domain stream may be performed, a circuit, within or separate from the above filter, whereby the significance of the PWM samples as assessed by the filter varies with time such as may be described by the filter having a variable impulse response, a circuit by which the average value may be found to be zero or sufficiently close to zero as determined by the resolution of the filter output, a circuit by which the filter average value being zero or close to zero is used to disconnect (or equivalently change impedance or power) of the device or devices rendering the PWM signal into the analog domain as may be implemented by a Class D bridge chip and disconnection circuitry.

The example shown is a third order sigma delta loop driving a pulse wave modulator (PWM) element. The intention is to convert an input signal expressed over many bits (typically 24) into a single bit stream of data output from the PWM element to be connected to a Class D power driver. The invention is directed to determining the best moment in which to disconnect the power driver from the output stream such that no click or pop is heard in the loudspeakers. The reason that a click or pop is heard is due to the average value of the signal not being zero at the time of disconnection. The invention is directed to assessing the average value of the signal for the purpose of indicating the ideal time for a shutdown of the output signal. I practice, this is non-trivial because the output signal is bounded and the average of the output signal oscillates. The actual phase of the oscillation of the average value depends upon the time at which the averaging process was started.

Therefore, a clear indication of the ideal time for shutdown cannot depend upon a simply derived average value. FIG. 2 illustrates this problem, where the two different triangular waves, A1 and A2, are shown off phase. A1 is the accumulation (the integral) of the signal—the integration process for Al is started at S1. A2 is another accumulation, but this time the integration process is started at S2. Each of these signals passes though zero, indicating the time when the average value is zero. But clearly each signal does not indicate the same time—they cannot both be correct. Empirical data shows that the ideal time for disconnection when a continuous 50:50 duty cycle is output is a point half way through either the high or low period—as shown in FIG. 3.

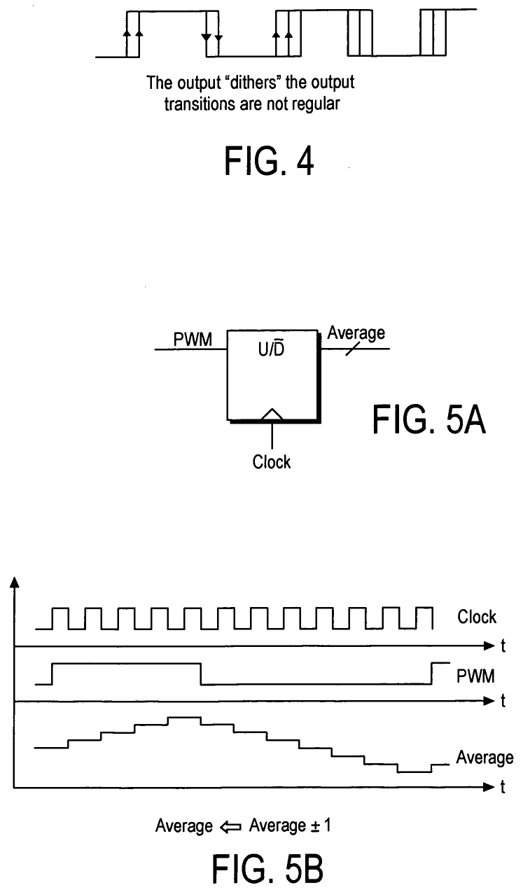

This is empirically found to be the ideal time—it corresponds to the average shown in A2 of FIG. 4. FIG. 3 shows a waveform that has a 50:50 duty cycle. However, only in the case of a first order modulator would the signal be exactly fixed. In a higher order modulator the exact transition times of the output are not fixed at the 50:50 points. There is dither in the output that causes the edges to move slightly as shown here in FIG. 4.

The invention is directed to a method of determining the time when the average value of the high order modulated signal (and hence not exactly repeating 50:50) is zero independently of the choice of starting time. If the output pulses of the PWM from the high order modulator are applied to an up/down counter such that the counter counts up when the signal is high and counts down when the signal is low, a digital representation of the average value can be created. FIG. 5 illustrates an example.

FIG. 5a is the up/down (U/D) counter, where, if the wire labeled U/D is high, the next clock edge will cause the average number to increase. In contrast, if it is low, it will decrease. The average value on the output bus of the U/D counter is seen to represent the average value of the PWM output as sampled by the clock. This demonstrates that an up down counter is sufficient to asses the average value of the output, but this up/down counter method would suffer from the problem of its dependency on the start point to indicate the correct result (i.e. it suffers from the problem shown in FIG. 2. that the start point influences the result).

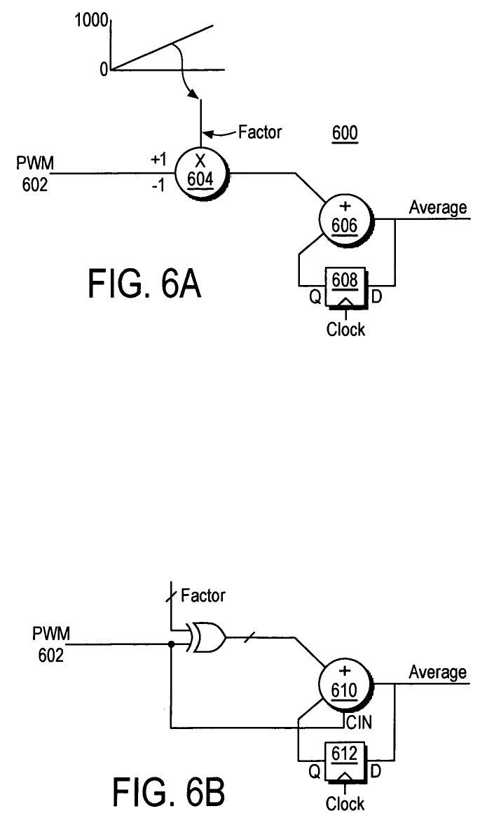

FIGS. 6a and 6b illustrate an up/down counter that is modified to accept an amount by which it is incremented or decremented, where the up/down counter changes by ±1, this configuration changes by ± a variable amount.

As illustrated in another embodiment, FIG. 6b, the circuit 600 includes a PWM 602 that multiplies a FACTOR by ±1 by multiplier 604 and that factor is then used to adjust the average value with adder 606 that outputs an average to D input of flip flop 608, that outputs Q output to adder 606. The sum output of the adder is the AVERAGE. FIG. 6a shows the multiplier as an explicit element. Multiplication is commonly a complex operation that uses significant resources. However, in the case where one of the multiplicands is a single bit, a set of simple exclusive-or gates can create the one's complement that can be adjusted to be the ideal 2's complement by use of the otherwise unused carry input of the adder in the accumulator. FIG. 6b illustrates this useful feature of the circuit, where the FACTOR is input to an exclusive OR gate along with the PWM output. The output is added in adder 610 with the output of flip flop 612, where the PWM input clocks the input CIN of the adder. The output Q of the flip flop 612 is added with the output of the flip flop 612.

On aspect of the invention the ramp indicated in the drawing. At the start of the integration process the factor value is zero. Over time it slowly increases to a significant value, 100 for example. Thus, as the stream of PWM data emerge from the loop they are averaged in this block, but the weight attached to the averaging process is not fixed—for the early samples the weight is low, the weight increased with time to a final value significantly more than its initial value. This procedure then delivers a zero crossing in the average value that does indeed correspond to the time when the average is zero and the output may be disconnected.

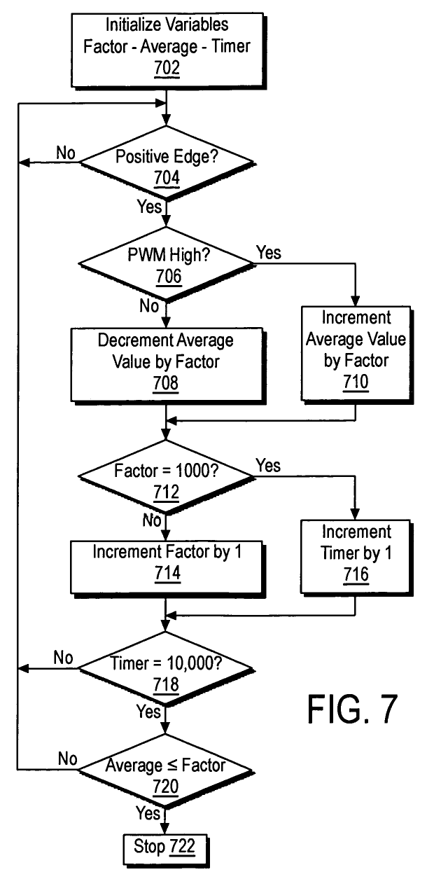

FIG. 7 illustrates a flow chart format of one implementation of the invention as follows. When it is desired to shut down a high order modulator's PWM output as used in high performance Class D circuits. Simply, the process is as follows:
1) In Step 702, Initialize the variables “Factor” and “Average” and “timer” to 0—next go to 704.
2) In step 704, Wait for a positive edge of the master clock—go to 706
3) In 706, query whether the PWM output high? If yes go to 710, else go to 708.
4) In 710, Increment the “Average” value by “Factor”—go to 712
5) In 708, Decrement the “Average” value by “Factor”—go to 712
6) In 712, query whether factor equal to 1000?—If yes go to 716 else go to 714
7) In 714 Increment “Factor” by 1—go to 718
8) In 716 Increment “timer” by 1—go to 718
9) In 718, query whether timer equal to 10000? If yes go to 720, else go to 704
10) In 720, query whether the absolute value of “Average” less than or equal to “Factor”?—if yes go to 722 else go to 704
11) In 722, Stop—this is now the time to shutdown the output.
   The flow chart of FIG. 7 gradually increments the factor value so adding more and more weight to the averaging process until the factor reaches 1000 at which point all PWM cycle contribute equally to the output. Then a time (10,000 clock cycles in this case) is waited after which the next zero crossing of the average value is used to indicate the output can now be disconnected. Note the zero crossing is assessed to within the “factor” value as is needed since at the end “average” is incrementing and decrementing by “factor”.

The invention has been described in the context of a system and method of removing artifacts from an audio signal during shutdown of the output. However, the embodiments described herein are not intended as limiting of the spirit and scope of the invention, which is defined by the appended claims.

1. A system for use in an audio signal processor to remove sound artifacts from an audio signal during shutdown of the output, comprising:
an input for receiving an audio input signal;
a noise shaping modulator to reduce the input bit width having an order of two or more;
means by which the reduced bit representation is converted to a single bit time domain output as may be done by a PWM element;
means by which a filtered or average value of the output single bit time domain stream may be performed;
means, within, or separate from the above filter, whereby the significance of the PWM samples as assessed by the filter varies with time such as may be described by the filter having a variable impulse response;
means by which the average value may be found to be zero or sufficiently close to zero as determined by the resolution of the filter output.
means by which the filter average value being zero or close to zero is used to disconnect (or equivalently change impedance or power) of the device or devices rendering the PWM signal into the analog domain as may be implemented by a Class D bridge chip and disconnection means.
